(19) United States
(12) Patent Application Publication
(10) Pub. No.: US 2007/0067176 A1
(43) Pub. Date: Mar. 22, 2007

(54) Television show business method for combining advertising and content

(76) Inventor: Christofer Lindheimer, Kista (SE)

Correspondence Address: POTOMAC PATENT GROUP, PLLC, P. O. BOX 270, FREDERICKSBURG, VA, 22404, US

(21) Appl. No.: 11/230,911

(22) Filed: Sep. 20, 2005

(51) Int. Cl. G06Q 99/00; G07G 1/14; G06Q 30/00

(52) U.S. Cl. 705/1; 705/14

(57) ABSTRACT

Methods for developing TV shows associated with marketing are described.

### BACKGROUND

The present invention pertains to business methods generally and, more particularly, to business methods for producing television shows which combine advertising and reality content.

Throughout the past 10-15 years, reality shows have become increasingly popular in commercial television. Many of the reality shows adopt non-professional actors or contestants to compete in one way or another, whether it be surviving on a deserted island, resisting infidelity in “paradise”, proving their lack of singing skills on stage or in more or less repulsive situations where they try to overcome what is perceived to be a fairly healthy “fear”. The current prevalence of such TV shows indicate that the concept is working, but it is also clear that this non-creative format market of reality show will soon become saturated. Thus, there is a continuing need for a range of more creative ideas that combine the useful aspects of reality shows and competition programs, while also adding a new, more creative pitch.

### SUMMARY

According to one exemplary embodiment of the present invention, a business method for generating a TV show, the TV show depicting a competition to develop a marketing product, the method includes the steps of: recording scenes associated with at least two teams for the competition; recording scenes associated with each of the at least two teams developing a respective marketing product; recording scenes associated with a presentation of the respective marketing products; determining a winning one of the at least two teams; and recording scenes associated with presentation to the winning one of the at least two teams.

### BRIEF DESCRIPTION OF THE DRAWINGS

The accompanying drawings illustrate exemplary embodiments of the present invention, wherein:

FIG. 1 depicts a business method for generating a TV show.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Exemplary embodiments of the present invention provide business methods which bring the viewers to the production site for creating the commercials. According to one exemplary embodiment of the present invention, competing teams have task of creating a “best” commercial for a company, a product or something to be advertised. Some examples will best serve to illustrate these exemplary embodiments.

Starting the show, there are at least two teams presented as the competing teams. Irrespective of how many persons there are in each team (1-several), this exemplary embodiment refers thereto as “competing teams”. Each team will be tasked with creating an advertisement for, for example, a particular product or thing to be marketed. In this example, the thing to be marketed is a product made by “Company X”. However the present invention is not so limited and the thing to be marketed could be a service or a place (e.g., the country of Portugal wants to market itself to tourists). The teams are formed of participants that have applied for participation. They can, for example, each be coached by an advertising professional. The advertising company (“CompanyY”) will provide these two coaches and their company name will also be visible in the TV show. (It is up to CompanyX to decide if CompanyY should be their current advertising firm or some other advertising firm that they currently don't do business with.)

Next, a presentation is made of the company, the product or the thing to be marketed that is to be the focus for this particular show. In this particular exemplary embodiment, a particular type of athletic shoes made by Company X are to be marketed. For example, suppose that CompanyX has recently released a new “street shoe” that targets consumers in all ages, women and men. The presentation of CompanyX and their new product, the “street shoe”, can for example include a video clip wherein representatives from CompanyX describe, for example, how the shoe came about, what it is made of, how it is made and what tests that have been made to secure its quality. This segment can be more of a documentary part of the show where both the contestants and the audience will start to be creative and consider how the question of how they should generate a promotion to sell this shoe.

Next, the competing teams are in focus. Snapshots of the creative thinking process, of the discussion, of mistakes made along the way and of possible arguments and conflicting opinions. In one example of the present invention, the competing teams can be specifically tasked with generating a commercial video as their output. According to other exemplary embodiments of the present invention, the output could be different, e.g., a radio jingle, selection of an ad partner, etc. Both of the teams will actually try to produce the film or other output itself. The audience is shown the production site selected, the way in which the different contestants gather enough crowd and actors to make the commercial video, the set-up etc. The teams also do some own research about the company and probably find threads in earlier commercials that they may or may not spin off of.

The prizes to be awarded to the winning team can be presented while the teams are working to put together their marketing entry. The winning team in this exemplary competition will receive an all-inclusive weekend in Jamaica, of course equipped with free street shoes and other gadgets that Company X also manufactures. There can be a number of breaks during this part of the show. For example, one break can include a response to criticism that CompanyX has received regarding their use of cheap labor in east-Asia for which they allegedly pay extremely low wages. This is responded to during the show as an aside e.g., by displaying a film clip about a factory in east-Asia where people are being interviewed and where different employee programs are presented to show people the other side to the story presented by, e.g., expose television shows. As other breaks, woven into the show there can be commercials about other sports gear, sports drinks, socks, roller blades, soft drinks, etc., which can be related to the “street shoe” which is the primary marketing focus of the show.

As the production of the video clips is proceeding, the different teams may argue/discuss amongst themselves for certain selections of sites, for certain thoughts regarding what the video should tell the public, what the message should be. Some or all of the interesting portions of these internal discussions can be related to the viewers as part of the show. Old commercials from the same company are shown and, possibly, reviewed by the teams. The team coaches, e.g., the advertising professionals, may comment on the progress of their respective team. The show can also include further presentations of the contestants, why they have applied for participation and what they want to get out of it.

When presenting the video clips, or other marketing product produced by each team, this can be done in connection with a vote from the studio audience and from people calling-in or sending SMS. The vote can be focused on the marketing impact of the commercial, e.g., by asking the audience to select which commercial makes them more strongly inclined to purchase the product in focus. Of course, the particular manner in which “winning” is determined can vary. Alternative embodiments may involve asking the public to decide upon the winner or the winner of the competition is decided by a jury. The jury could then be ad professionals, company officials, a combination of both or any other setup of professional judgers, e.g., psychologists. A jury could be combined with a public vote.

Regardless of the manner in which the winner is selected from among the teams, a winner is announced. CompanyX may then have an opportunity to buy the commercial videos and the competing teams may receive some royalty or financial windfall if the company elects to purchase the commercial. This could apply for all competing teams or just the winning team. It may occur in “real time” or Company X may have until the next show to decide how much it is willing to pay for the commercial clips produced in the show. The show can end with announcing the outcome from a previous show. Did the company buy the output from last week? How much did it bring in to that weeks non-profit organization? The next show's company or focus is presented and application information for participation is repeated.

A number of variants on the foregoing exemplary embodiment are possible and are contemplated by the present invention. A few such variants are described below.

Varying the Teams

Adedition Professional

In one edition (episode) of Adedition (or several programs) there may be an Adedition Professional, where professional advertising firms are competing with each other. Adedition Professional may even be a complete series of programs, e.g., combined with other variants like Adedition New Orleans, or where Adedition travel around trying to “sell” specific cities and places for purposes of tourism or advertising for universities or for getting companies to establish at certain locations.

Adedition Amateur

Here, the public may apply for being a part of a contestant team

Adedition Audience

This is a version of Adedition that is best suited to be conducted with products rather than companies and where an auction of the productions that constitute output of the show may take place. The Adedition Audience is formed of a team, probably with professional or semi-professional (advertising student) guidance, that have as a task to make a commercial campaign on advice from the viewers or a studio audience or both. Profit may be generated through even another channel, that of dial-in earnings. SMS may be charged in addition while the Audience tips are competing for a price, e.g., probably related to the product that advertising is to be valid for.

Adedition Student

Student Adedition is made solely for advertising students and for allowing students that major in advertising to prove their abilities and show their products. This is a variant of Adedition that may be sponsored by companies and educational institutions.

Adedition Celebrity

Of course, well-known celebrities should be welcomed to join in. The celebrities should get free exposure and they will add to the popularity of the show and assumedly attract even more viewers.

Varying the Production Places

Adedition OnLocation

As Adedition does not require a huge and expensive production setup it is suitable for “roadshow” productions. Adedition could visit different cities and where the contest part of the show could be to “sell a location” to tourists and investors. “Adedition, soon promoting your hometown” is certainly a good slogan. Commercials should here be given to local companies and especially companies that are contributing to the production, e.g., hotels that give discount for participants, restaurants that offer participants free dinners etc.

Companies or Merely Product Types

Adedition Company X

In Adedition “Company X” a specific company is targeted, similar to what is outlined in the detailed description. This is believed to be the most direct and straightforward way of setting up the show and the easiest and most straight-forward way to be able to raise fundings. Company X will, to a large part be determining the content of the show, what commercials to allow in the break, how the competing teams should be formed, if there should be any part of the profits going to charity, if the audience should be involved somehow, how liberal the dialogue should be and to what level the show should be pre-recorded. The company would form the show together with the production crew and in return, get a controlled publicity.

“Adedition Soap”

In “Adedition Soap” the idea is to conduct a more generic show that is funded by different companies that produce soap. The production may then, to the least possible extent target specific companies, rather the concept “Soap” (Soap is an example, it may very well be “Adedition Shoes” or something completely different.) The benefit with this is that would be easier to have amateurs accepted in the competing teams than with the Company X case, where there is a company name in focus. On the other hand, the sponsoring may be more difficult. In Adedition Soap or any other specific product type version of Adedition, the outcome of the contest, the right to the commercials may very well be auctioned among production companies, advertising companies or similar. This would then be a source of income for the show, for the contestants as well as for the idea owners. [But of course, Adedition should own the right to the ideas also]

Adedition Charity

A TV show that has a touch of fundraising may be perceived in a better way than a show that doesn't have that ingredient and people (audience) are more inclined to open their own wallets. A charged SMS/dial-in service could aid in the fund-raising further or, with a slogan like “for each $ contributed to by the public, Company X will match this contribution.”

Additional Competition,—Adedition ComQuiz

In one version of Adedition, or even as a separate show, there is a ComQuiz part, where a set of (other) teams compete against each other in “commercial recognition”. The competition is about recognizing the commercial and the company or product it refers to just by being shown a picture, part of a video clip from a commercial video, or a slogan. This is a traditional competition where the team that first knows the answer makes a distinguishable sound or similar and gets to answer the question first. The answer could then be the company name. ComQuiz could be used as a qualifying method for a participation in an Adedition show, e.g., to select contestants to form the teams. It may then be broadcast as part of the entire Adedition show. The winning team will meet next shows runner-up or there could be two (or more) new teams the next show. The main aim with ComQuiz would be to increase the public interest for commercials, i.e., by again putting the commercials in focus.

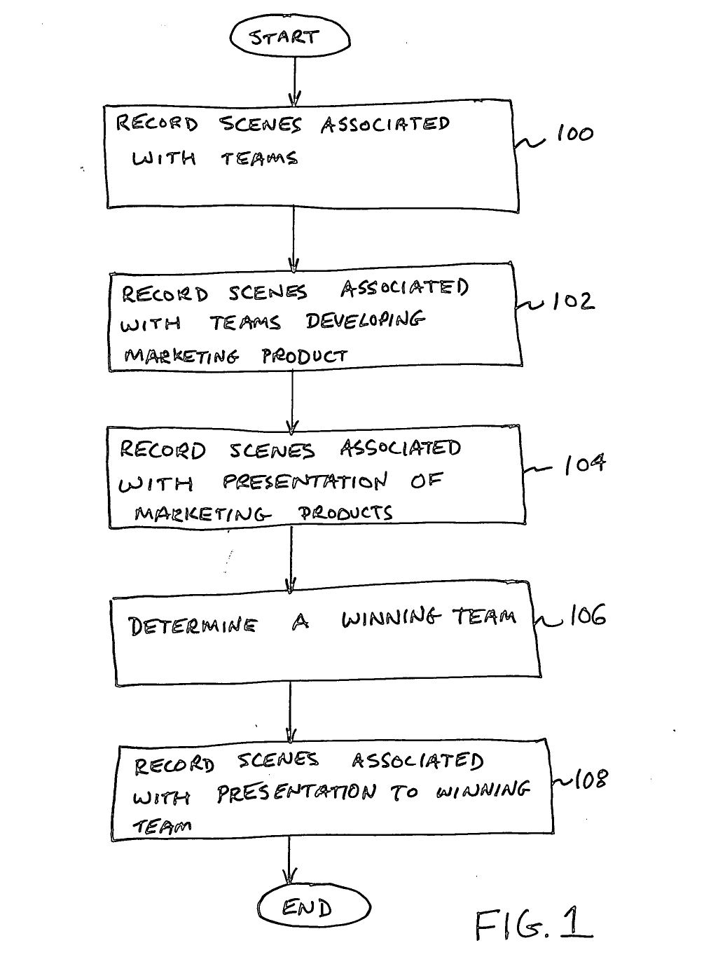

It is contemplated that the foregoing exemplary shows will be reduced to an electronically conveyable format by first recording such content on a recordable medium, e.g., film, etc. and then by electronically distributing such content, e.g., via air, cable or satellite. Thus, according to one exemplary embodiment of the present invention, a business method for generating a TV show is illustrated by the flowchart of FIG. 1. Therein, the TV show depicts a competition to develop a marketing product, and the method includes the steps of recording scenes associated with at least two teams for the competition (step 100), recording scenes associated with each of the at least two teams developing a respective marketing product (102), recording scenes associated with a presentation of said respective marketing products (104), determining a winning one of the at least two teams (106) and recording scenes associated with presentation to said winning one of said at least two teams (108). Although not illustrated herein, the term “recording” could also be replaced with the term “broadcasting” or “electronically distributing” to reflect other exemplary embodiments of the present invention wherein the above-described content is distributed to end user's televisions. Some portions of the show may be pre-recorded, e.g., scenes evidencing the evolution of a team's commercial coming together over time, whereas other portions may be “live”, e.g., presentation of the commercial for the first time to a live studio audience as well as home viewers.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing exemplary embodiments describe two teams competing to generate a commercial, a variant could have only one team and eliminate the competition aspect while focusing on the creative aspects of commercial generation. The show can be used to provide feedback to the company for potential commercial offerings. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A business method for generating a TV show, said TV show depicting a competition to develop a marketing product, said method comprising the steps of:
recording scenes associated with at least two teams for said competition;
recording scenes associated with each of said at least two teams developing a respective marketing product;
recording scenes associated with a presentation of said respective marketing products;
determining a winning one of said at least two teams; and
recording scenes associated with presentation to said winning one of said at least two teams.

2. The business method of claim 1, wherein said marketing product is a television commercial and said method further comprises the step of:
generating, by each of said at least two teams, a television commercial on a recordable medium.

3. The business method of claim 2, further comprising the step of:
recording scenes associated with an introduction of a thing to be promoted by said marketing product.

4. The business method of claim 3, wherein said thing is a shoe.

5. The business method of claim 3, wherein said thing is manufactured by a company and further comprising the step of:
controlling, at least in part, selection of said recorded scenes, by said company.

6. The business method of claim 1, wherein said step of recording scenes associated with said at least two teams for said competition further comprises the steps of:
filming biographies of each contestant within said at least two teams and personal interviews indicating why each contestant is interested in marketing.

7. The business method of claim 1, wherein said step of recording scenes associated with each of said at least two teams developing a respective marketing product further comprises the step of:
filming said at least two teams independently developing a television commercial intended to market a predetermined thing.

8. The business method of claim 1, wherein said step of recording scenes associated with a presentation of said respective marketing products further comprises the step of:
filming a presentation of a commercial developed by each of said at least two teams.
